(19) United States
(12) Patent Application Publication
(10) Pub. No.: US 2013/0160913 A1
(43) Pub. Date: Jun. 27, 2013

(54) TIRE WITH LABEL AND RELIEF GROOVE

(71) Applicants: Satyajit Avinash Lonkar, Broadview Heights, OH (US); Philip Carl Van Riper, Cuyahoga Falls, OH (US); Mingliang Du, Akron, OH (US); Madhusudhana Srinivasa Rao Kirugulige, Akron, OH (US); Frank Helmut Bucher, Konz (DE); Matthew Jared Edson, Akron, OH (US)

(72) Inventors: Satyajit Avinash Lonkar, Broadview Heights, OH (US); Philip Carl Van Riper, Cuyahoga Falls, OH (US); Mingliang Du, Akron, OH (US); Madhusudhana Srinivasa Rao Kirugulige, Akron, OH (US); Frank Helmut Bucher, Konz (DE); Matthew Jared Edson, Akron, OH (US)

(21) Appl. No.: 13/708,271

(22) Filed: Dec. 7, 2012

Related U.S. Application Data
(60) Provisional application No. 61/579,245, filed on Dec. 22, 2011.

(51) Int. Cl. B60C 13/00

(52) U.S. Cl. CPC B60C 13/003
USPC 152/523; 156/123

(57) ABSTRACT

A pneumatic tire comprising a tread and a sidewall with a flat label region is disclosed. One or more grooves may surround the flat label region. The flat label region may in its entirety be raised from the surface of the tire. A method of forming a label on a tire sidewall is also disclosed, wherein, the method includes the steps of: providing a tire mold having a sidewall plate with a cavity; inserting a label mold in said cavity, curing the tire in the mold and forming a first surface layer on the sidewall of the tire; removing the tire from the mold, and affixing a decorative label to the first surface area.

### FIELD OF THE INVENTION

The invention relates in general to rubber articles and more particularly to tires.

### BACKGROUND OF THE INVENTION

Pneumatic tires often desirably have indicial markings commonly known as labels located on the sidewalls of the tire. The tire labels typically include information such as trademarks or other markings. These indicia typically are formed directly into the rubber sidewall during the tire molding process. Thus, the indicia may be raised lettering or other shapes, and may be colored with white pigments or other colorants in the rubber compound. The current trend is to mold the label into the tire sidewall. The label is formed of the black tire sidewall, and is visible to the eye due to the use of different patterns of molded ridges. The letters or other indicia typically have a different angle or pattern of ridges so that a consumer can read the label. See for example, U.S. Pat. No. 5,645,661.

Tires having other types of appliques on the sidewalls thereof, such as lettering, logos, decals, or bar codes and the like, are also very popular. It is known in the prior art to apply stickers or decals to the tire sidewall after the tire has been cured. However, due to the repeated cyclic deformation of the tire sidewall, the decals generally fall off due to inadequate adhesion. Further, if the tires contact a curb, or other surface, the decals will be rubbed or scraped off.

It has also been proposed to replace the previously known sidewall decorative features with appliques which are painted onto conventional black wall tires. However, painting designs on to the sidewall of tires has not proven to be a satisfactory answer to the problem. This is largely due to the fact that designs which are painted on are quite thin and are damaged by the repeated flexing of the sidewalls.

It would, therefore, be desirable to have a tire with indicia applied to a cured tire sidewall surface, wherein the indicial coating material offers good adhesion and durability.

### SUMMARY OF THE INVENTION

The present invention provides a pneumatic tire comprising

### BRIEF DESCRIPTION OF THE DRAWINGS

FIG. 1 is a perspective view of a partial section of a sidewall of a tire illustrating an exemplary label.

FIG. 2a is a partial view of a tire mold showing the tire label mounted in the sidewall forming section of the tire mold;

FIG. 2b is a front view of a tire sidewall plate showing the position of the tire label mold with respect to the sidewall;

FIG. 2c is perspective view of the tire mold and the corresponding tire label and sidewall formed by the mold;

FIG. 3 is a perspective view of the back side of a label having grooves.

FIG. 4 is a perspective view of a portion of a sidewall of a tire showing a raised flat pad with a stress relief groove.

FIG. 5 is a perspective view of a portion of a sidewall of a tire showing a raised flat pad with a tire decal applied post cure, wherein the flat pad is surrounded by a stress relief groove.

### DETAILED DESCRIPTION OF THE INVENTION

The present invention relates to a label for a pneumatic tire. The pneumatic tire may comprise any vehicle tire such as a passenger tire; light, medium or heavy truck tires, off-the-road tires, farm tires, mining tires, aircraft tires, motorcycle tires, and the like. The vehicle tire may also be bicycle tires or tires for toy articles. In an alternative embodiment, the label may be used for a rubber article, such as, but not limited to, a door mat, a car mat, and other rubber articles.

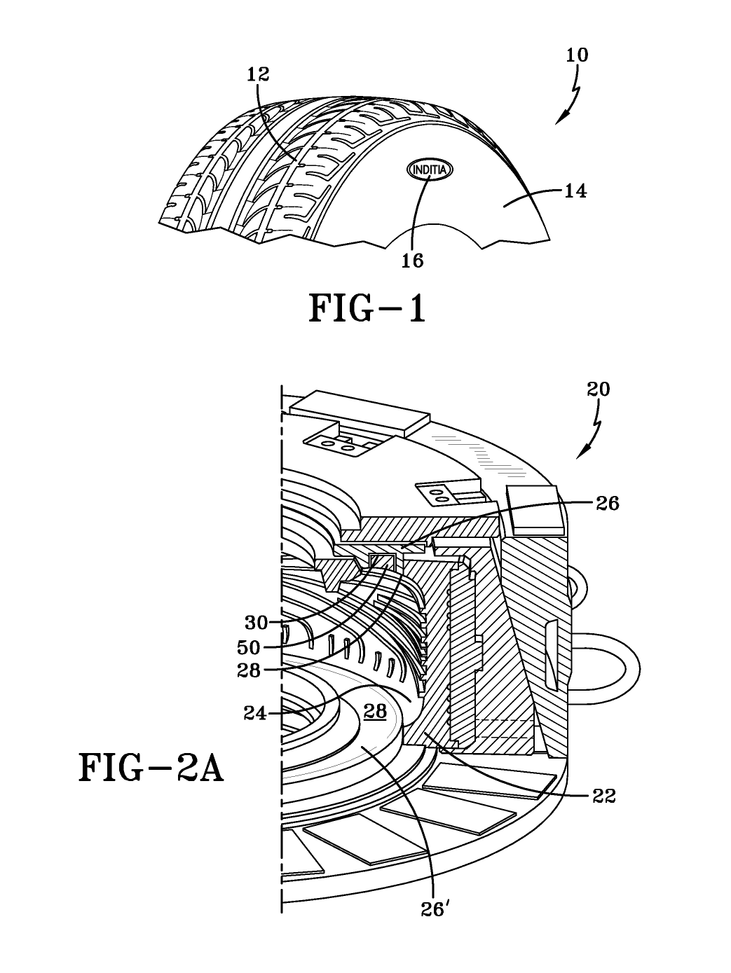

FIG. 1 illustrates a portion of a tire 10 having a tire tread 12 and a tire sidewall 14. The tire further comprises a tire label 16 mounted on the sidewall. The tire label may have alpha numeric characters and the shape of the label may be in any desired size, shape or color, such as lettering, trademark figures or logos, and the like. The indicia may also be in the shape or pattern of a sidewall stripe or stripes, such as for a white sidewall. Also envisioned as indicia are decorative markings, such as artistic designs, symbols, flowers, dots, short parallel and/or angled stripes or hash marks, or any other shapes as are desired by the user of the tire. The size of the label may be any desired size, and may also include the entire surface of the sidewall of the tire.

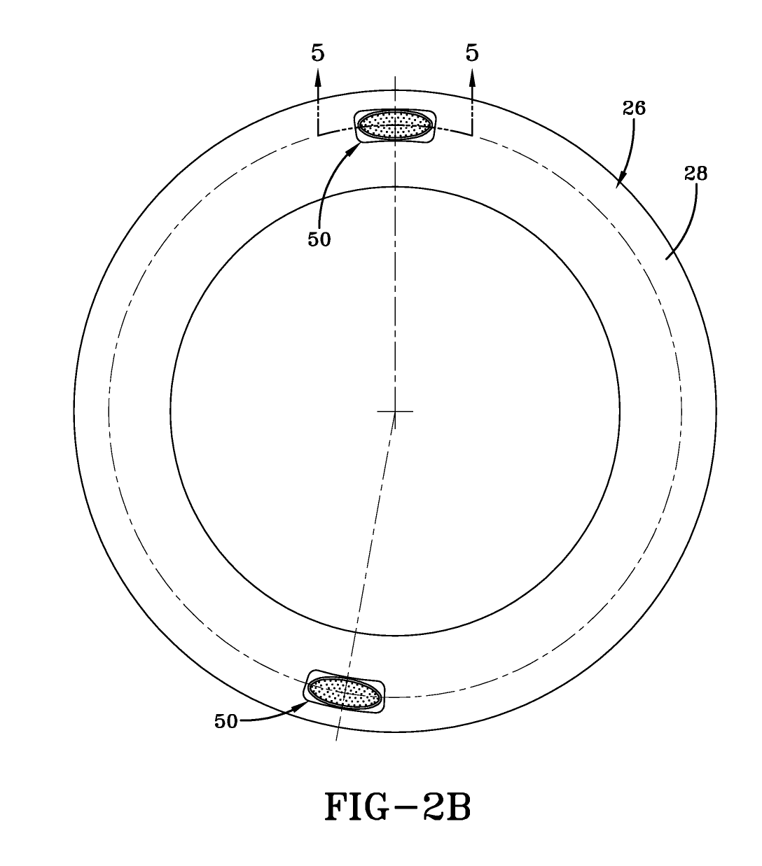

FIG. 2A illustrates a typical mold 20 used for molding a green tire. The mold assembly 20 typically comprises a plurality of segments 22 which are arranged to form an annular ring to encircle the tread of a green tire when the segments are assembled together. The outer tread surface of a tire is formed by the inner molding surface 24 of the segments 22, which have a plurality of lands and grooves to mold the tread pattern into the green tire. The mold segments 22 may be radially movable to allow assembly and disassembly of the mold about a green tire.

The mold assembly 10 further comprises a sidewall plate 26 for molding the sidewalls 14 of the tire. The sidewall plate 26 has an inner mold surface 28,28′ for molding the tire sidewall, and joins with the segments to form a smooth continuous surface from the tire tread to the sidewall. The sidewall plate 26 further comprises an inner cavity 30 for receiving a label mold 50, as described in more detail, below.

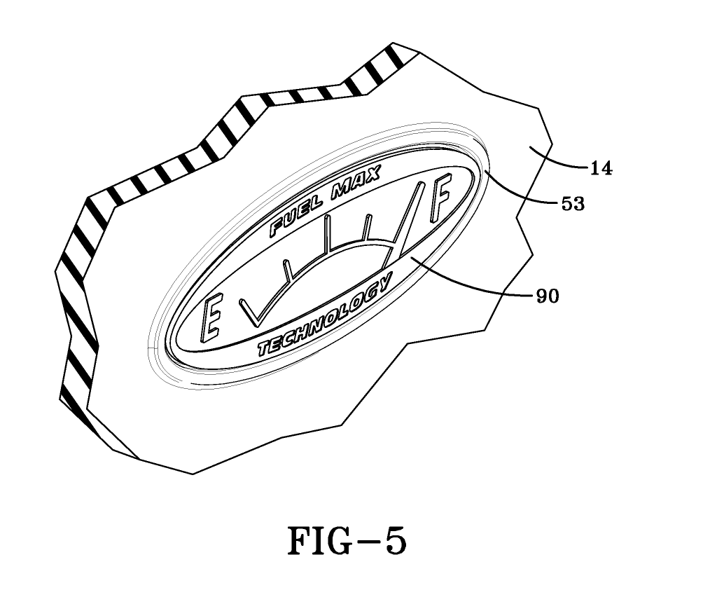

The label mold 50 molds a first surface layer 52 on the sidewall of the tire. The first surface layer 52 is shown in this example to be slightly raised from the surface of the tire sidewall, although not required. The first surface layer may be recessed (not shown) or flush with the sidewall of the tire (FIG. 5). An optional raised rim 53 (not shown) may encircle the first surface layer 52 to define the label region 52. One or more grooves 70 encircles the first surface layer 52 and functions to provide strain relief. If there is more than one groove 70, the grooves may be concentric.

The label mold 50 forms the label region 52 including the first surface layer 52, and the one or more grooves 70 and the optional raised rim 53. The label mold 50 is shown in FIG. 2c, and has an outer surface 60 that is to be located adjacent the outer sidewall surface of a green tire. The outer surface further comprises a recessed portion 62 that forms the raised label region 52 on the tire. The recessed portion 62 is encircled by a raised ridge 66 that forms the recessed groove 70 on the green tire sidewall.

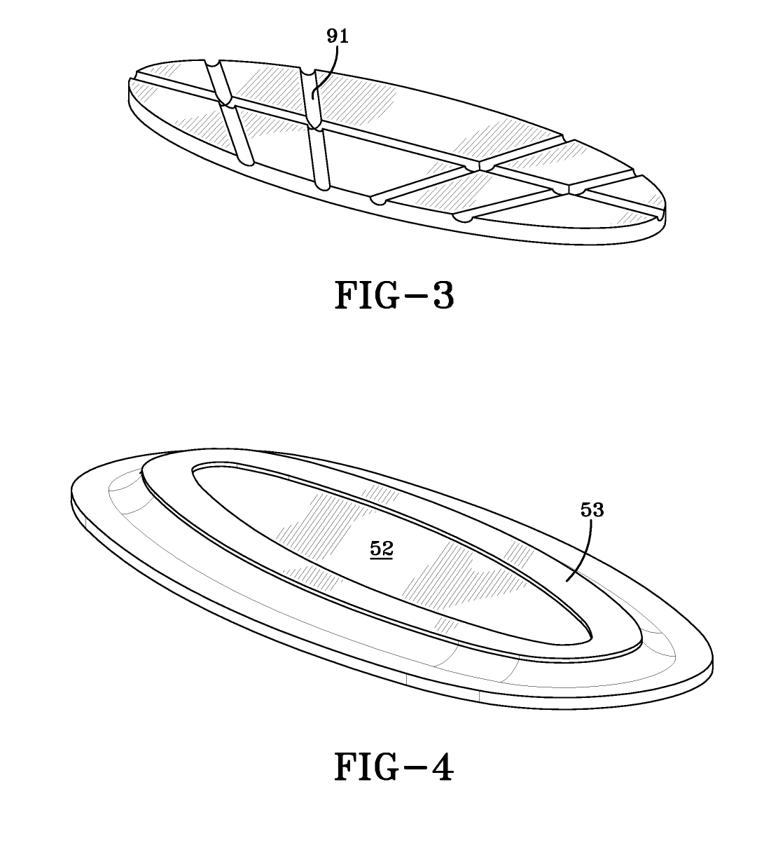

FIG. 4 illustrates a portion of a tire sidewall that has been cured in the tire mold. The tire sidewall has a raised first surface layer 52 molded into the tire sidewall. An optional raised rim 53 encircles the first surface layer 52. FIG. 5 illustrates a decorative label 90 affixed to the label region. The decorative label 90 is affixed post cure to the label regions described above using a rubber adhesive.

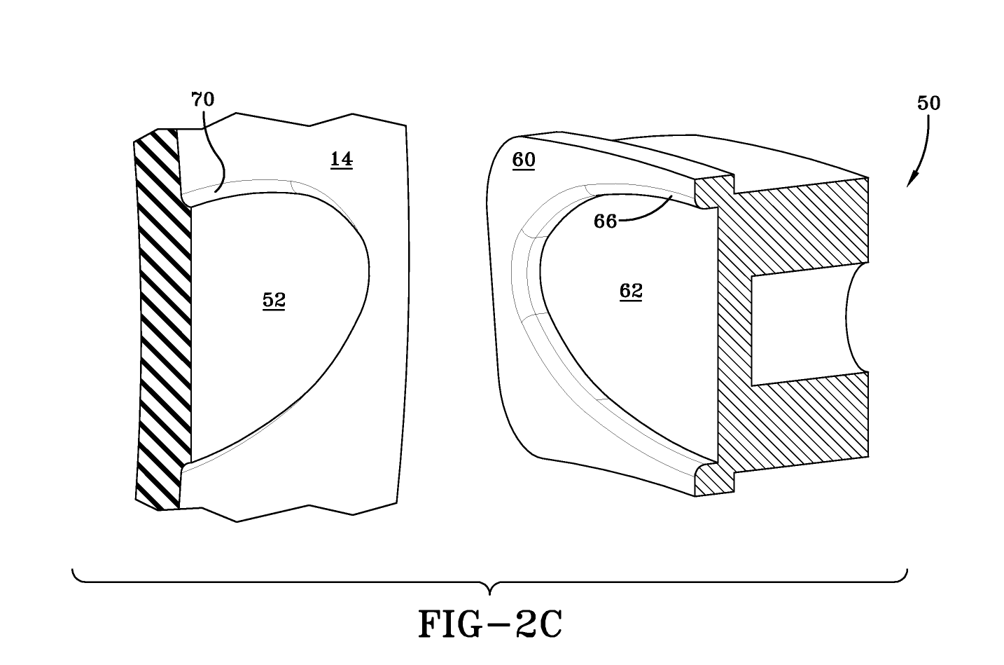

The decorative label 90 may have an outer visible layer 92 formed of a polymer such as a flexible polyvinyl chloride layer (PVC). The outer visible layer is bonded to a rubber or fabric backing. As shown in FIG. 3, the rubber or fabric backing of the decorative label 90 preferably has a plurality of grooves 91 which provide a reduction in strain. The fabric or rubber backing is affixed to the label region 52 post cure using a suitable adhesive. Suitable adhesives include those formed from or based upon cyanoacrylate adhesive, urethane, epoxy, polyvinyl alcohol, acrylate, methacrylate, polyvinyl chloride, polyester and the like.

While present exemplary embodiments of this invention and methods of practicing the same have been illustrated and described, it will be recognized that this invention may be otherwise variously embodied and practiced within the scope of the following claims.

We claim:

1. A pneumatic tire comprising a tread and a sidewall, said sidewall having a flat label region, and one or more grooves surrounding the flat label region.

2. The pneumatic tire of claim 1 wherein the flat label region is recessed from the sidewall surface.

3. The pneumatic tire of claim 1 wherein the flat label region is raised from the sidewall surface.

4. The pneumatic tire of claim 1 further including a label mounted on the flat label region.

5. The pneumatic tire of claim 2 wherein the label is formed of polyvinyl chloride.

6. The pneumatic tire of claim 2 wherein the label is colored.

7. The pneumatic tire of claim 4 wherein the label has a visible side and a backing side, wherein the backing side has one or more grooves.

8. A method of forming a label on a tire sidewall, the method comprising the steps of: providing a tire mold having a sidewall plate with a cavity; inserting a label mold in said cavity, curing the tire in the mold and forming a first surface layer on the sidewall of the tire; removing the tire from the mold, affixing a decorative label to the first surface area.

9. The method of claim 8 wherein the first surface layer projects from the sidewall of the tire.

10. The method of claim 8 wherein the first surface layer projects from the sidewall of the tire, and a recessed groove surrounds the first surface layer.

11. The method of claim 8 wherein the decorative label has a back side having one or more grooves.
